(19) United States
(12) Patent Application Publication
(10) Pub. No.: US 2008/0143695 A1
(43) Pub. Date: Jun. 19, 2008

(54) Low power static image display self-refresh

(76) Inventors: Dale Juenemann, Forest Grove, OR (US); Kim Meinerth, Lake Oswego, OR (US)

Correspondence Address: INTEL CORPORATION;c/o INTELLEVATE, LLC, P.O. BOX 52050, MINNEAPOLIS, MN, 55402, US

(21) Appl. No.: 11/642,174

(22) Filed: Dec. 19, 2006

(51) Int. Cl. G09G 5/00

(52) U.S. Cl. 345/204

(57) ABSTRACT

A method, apparatus, and system for low power static image display self-refresh are described. In one embodiment, a display controller may operate in a primary display mode or in a low power display mode. The display controller may switch from a primary display mode to a low power display mode when the displayed image has been static for a predetermined time, and may switch from the low power display mode to the primary display mode when the display buffer changes.

### FIELD

Embodiments described herein relate to the field of display technology, and more particularly, to display self refresh.

### BACKGROUND

LCD displays, like many display technologies, are refreshed many times per second.

Some LCD display panels incorporate embedded frame buffers, allowing display self refresh. However, handheld mobile computing devices typically incorporate LCD displays that do not include frame buffers, due to cost considerations.

LCD displays that do not include embedded frame buffers may refresh regardless of whether the displayed image changes. This can lead to increased power consumption and decreased battery life for mobile and/or handled computing devices.

### BRIEF DESCRIPTION OF THE DRAWINGS

A better understanding of embodiments of the present invention can be obtained from the following detailed description in conjunction with the following drawings, in which:

FIG. 1 is a block diagram illustrating a display controller operating in a primary display mode according to some embodiments.

FIG. 2 is a block diagram illustrating a display controller operating in a low power display mode according to some embodiments.

FIG. 3 is an illustration of a flow diagram according to some embodiments.

FIG. 4 is an illustration of a system according to some embodiments.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

According to some embodiments, a display controller may operate in a primary display mode or in a low power display mode. The display controller may switch from a primary display mode to a low power display mode when the displayed image has been static for a predetermined time, and may switch from the low power display mode to the primary display mode when the intended image to be displayed changes. A change in the contents of display buffer may indicate a change in the intended image to be displayed.

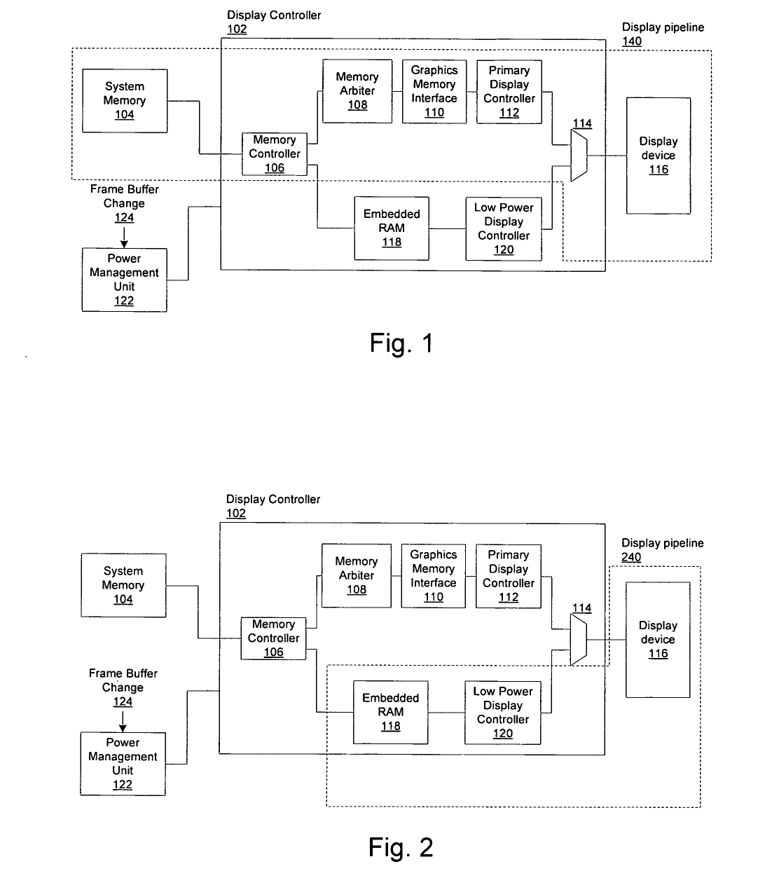

FIG. 1 is a block diagram illustrating a display controller unit (102) operating in a primary display mode according to some embodiments. The display controller unit (102) is coupled to a system memory (104). In some embodiments, the system memory (104) may be a random access memory (RAM), such as, for example, a dynamic random access memory (DRAM).

The display controller unit (102) is also coupled to a display device (116). In some embodiments, the display device may be a liquid crystal display (LCD) that does not include an embedded frame buffer.

The display controller unit (102) may include a memory controller (106), memory arbiter unit (108), graphics memory interface (110), primary display controller (112), a low power display controller (120), embedded memory (118), and a multiplexer (114). A power management unit (122) may be coupled to the display controller unit (102).

The display pipeline (140) illustrates the flow of data from system memory (102) to the display (116) via the display controller (102) in a primary display mode according to some embodiments. In the primary display mode, the display controller unit (102) may retrieve dynamic image information from system memory (104). The image information may be processed by the display controller unit (102), for example, by the graphics memory interface (110). The primary display controller (112) may control the transfer of the image information to a display device (116).

In some embodiments, primary display mode may be used predominantly to display dynamic images on the display device. A low power display mode may be used to display static images on the display device when the displayed image has been static for a predetermined time.

FIG. 2 is a block diagram illustrating the display controller unit (102) operating in a low power display mode according to some embodiments.

When a static image is detected, the power management unit (122) may switch the mode of operation of the display controller from a primary display mode to a low power display mode. The display pipeline (240) illustrates the flow of image data from an embedded memory (118) to the display (116) via a low power display controller (120) in the low power display mode.

The memory arbiter unit (108) or another logic block within the display controller (102) may include an address range detector to monitor writes to any address in a frame buffer memory region within system memory (104). In some embodiments, the address range detector may be implemented in hardware. The frame buffer memory region may be defined by configuration registers in the system that store both a physical starting address and a range for the frame buffer. In some embodiments, the frame buffer may be implemented as contiguous physical memory. In other embodiments, the frame buffer may be defined by a logical address range.

When the memory arbiter unit (108) detects a write to an address in the frame buffer memory region in system memory (104), it may trigger an event and send a frame buffer change signal (124) to the power management unit (122).

In addition, the memory arbiter unit (108) may also detect display flips. A display flip is defined as the event that occurs when the display address register has been written with a new address. When the memory arbiter unit (108) detects a display flip, it may send a frame buffer change signal (124) to the power management unit.

In some embodiments, the frame buffer change signal (124) sent by the memory arbiter (108) to the power management unit (122) may be a pulsed signal of one clock cycle for each write to memory within the frame buffer range.

The power management unit (122) monitors the frame buffer change signal (124) sent by the memory arbiter (102) or other logic block. In some embodiments, when the power management unit detects that no frame buffer changes or display flips have occurred for a predetermined period of time, it will switch the display controller into a low power display mode. In some embodiments, the predetermined time may be programmable, for example, in hardware configuration registers.

In other embodiments, when the power management unit detects that no frame buffer changes or display flips have occurred over a predetermined number of frames, it will switch the display controller into a low power display mode. The predetermined number of frames may be programmable in hardware configuration registers.

In some embodiments, upon entry into the low power display mode, the power management unit (122) enables the memory controller (106) to perform frame compression of the static image frame as it is retrieved from system memory (104) and placed into an embedded random access memory (RAM) (118). The embedded RAM may be at least one megabyte (MB) in size, however, in some embodiments a smaller embedded RAM may be used.

In some embodiments, frame compression of the static image frame may occur at the end of the display processing pipeline, which may include multiple display streams (e.g., primary display surface, video overlay). The compressed image may then be transferred to the embedded RAM. When frame compression is performed at the end of the display processing pipeline and the compressed image is then stored in the embedded RAM, it will not be necessary to perform compression upon entry into the low power display mode.

The power management unit further switches the display pipeline from the primary display mode to the low power display mode. In some embodiments, a multiplexer (114) may be used to switch the display pipeline.

The low power mode display pipeline (240) includes the embedded memory (118) and the low power display controller (120). The low power display controller (120) retrieves compressed static image information from an embedded memory (118) to display on a display device (116). The static compressed image is displayed by the low power display controller for every refresh cycle at a rate that is at least equal to the minimum rate required to maintain display integrity until the display controller (102) exits the low power display mode.

In some embodiments, while the display controller is operating in low power display mode, the power management unit (122) may employ one or more power saving mechanisms for one or more blocks within the display controller. In some embodiments one or more blocks within the display controller that are not being used may be powered off by the power management unit (122). For example, the graphics memory interface (110) may be powered off during the low power display mode. In other embodiments, the power management unit (122) may stop the clocks to one or more of the blocks within the display controller. In yet other embodiments, the diode bias may be reversed for one or more blocks in the display controller in order to lower the leakage current. Other power saving mechanisms may be used as well.

In addition, the system memory (104) may also operate in a low power mode, such as self-refresh, while the display controller (102) is operating in low power display mode.

The power management unit (122) may switch from low power display mode back to the primary display mode automatically when the display buffer changes or when a display flip occurs. Either occurrence may be indicated by the frame buffer change signal (124).

The display device (116) may refresh a number of times each second. Between each refresh, there is an idle period called “vertical blank.” The power management unit (122) may ensure that the switch between the primary display mode and the low power display mode occurs during vertical blank. This may prevent display glitches or other visible artifacts. Thus, the power management unit (122) may monitor for changes to the display buffer during a display refresh in order to determine which mode should be used during the next display refresh.

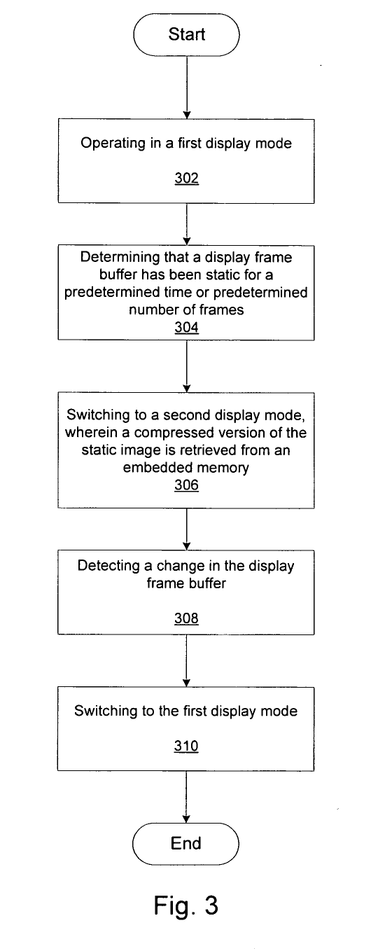

FIG. 3 is a flow diagram illustrating a process for changing from a primary display mode to a low power display mode according to some embodiments.

The process begins with a display controller operating in a first display mode (block 302). In some embodiments, the first display mode may be a primary display mode. In the primary display mode, the display controller may retrieve dynamic image information from system memory.

Hardware may determine when the display frame buffer has been static for a predetermined time (block 304). In some embodiments, logic within the display controller may assert a signal whenever the frame buffer changes. A power management unit may receive this signal and use it to determine if the display frame buffer has been static for either a predetermined period of time or a predetermined number of frames.

When the display frame buffer has been static for a predetermined time or a predetermined number of frames, the display controller may be switched to a second display mode (block 306). In some embodiments, this may be a low power display mode. In this mode, a compressed version of the static image may be retrieved from an embedded memory to be displayed on a display unit. Additionally, in the low power display mode, blocks within the display controller may be powered down or placed in a low power mode. System memory may be placed in a low power mode as well.

Hardware may determine when the display frame buffer changes (block 308). A signal may be sent to the power management unit when the display frame buffer changes.

When the display frame buffer changes, the power management unit may switch the display controller back to the primary display mode from the low power display mode (block 310). In some embodiments, the display mode change may occur during the display's vertical blank period.

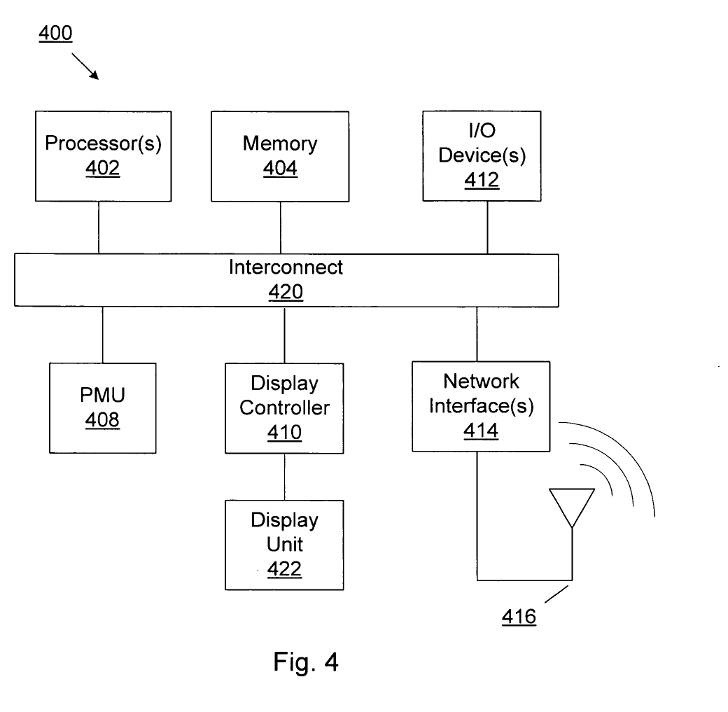

FIG. 4 is a block diagram of an electronic system (400) according to some embodiments. The electronic system illustrated in FIG. 4 is intended to represent a range of electronic systems, for example, computer systems, mobile or handheld computing systems, personal digital assistants (PDAs), cellular telephones, etc. Alternative systems may include more, fewer and/or different components.

While the electronic system (400) is illustrated with a single processor (402) coupled to an interconnect (420), the system may include multiple processors and/or co-processors, or one or more processors having multiple cores.

The system may further include random access memory (RAM) or other memory device (404), coupled to an interconnect (420). The memory (404) may include a frame buffer region to store image data for display on a display unit (422). The frame buffer may be implemented as contiguous physical memory or a logical address range. The memory may further store information and instructions to be executed by the processor (402). The memory (404) may further be used to store temporary variables or other intermediate information during execution of instructions by the processor (402).

The processor (402) may also be coupled via the interconnect (420) to one or more input/output (I/O) devices (412). In some embodiments, I/O devices coupled to the system may include an alphanumeric input device, such as a keyboard, and/or a cursor control device, such as a mouse, a trackball, or cursor direction keys, or other similar I/O devices.

The system may also include a display controller unit (410) coupled to the interconnect (420). The display controller unit may be capable of operating in at least two display modes, a primary display mode and a lower power display mode, as described above. The display controller unit may include a memory controller, an embedded memory, a primary display controller, and a low power display controller. The embedded memory in the display controller unit may be used to store a compressed static image for display by the low power display controller while in a low power display mode.

The display controller unit (410) may be coupled to a display unit (422). In some embodiments, the display unit is a LCD display that does not include a frame buffer.

A power management unit (408) may be coupled to the display controller unit (410) via the interconnect (420). The power management unit may determine whether the display frame buffer has been static for a predetermined time, and if so, may switch the display mode of the display controller unit from a primary display mode to a low power display mode. The power management unit may be further coupled to other components in the system, and may manage the power delivered to these components. For example, when the display controller (410) is in a low power display mode, the power management unit (408) may power off unused blocks within the display controller unit (410) and/or may place the system memory (404) in a low power mode, such as self-refresh. In addition, the power management unit may perform other system power management tasks.

The electronic system (400) may further include one or more network interface(s) (414) to provide access to a network, such as a local area network. The network interface(s) may include, for example, a wireless network interface having an antenna (416), which may represent one or more antenna(e). In one embodiment, the network interface(s) (414) may provide access to a local area network, for example, by conforming to IEEE 802.11b and/or IEEE 802.11g standards, and/or the wireless network interface may provide access to a personal area network, for example, by conforming to Bluetooth standards. In addition to, or instead of, communication via wireless LAN standards, the network interface(s) may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

In some embodiments, two or more blocks within the system may be combined in a single package, or on a single piece of silicon as a system on a chip (SOC). For example, the processor (402), power management unit (408), and display controller (410) may be integrated together as a system on a chip. The system on a chip may include other blocks as well, including the network interface (414) or other elements that are commonly found in computing systems but are not illustrated here for the sake of simplicity.

The methods set forth above may, in some embodiments, be implemented via instructions stored on a machine-accessible medium which are executed by a processor. The instructions may be implemented in many different ways, utilizing any programming code stored on any machine-accessible medium. A machine-accessible medium includes any mechanism that provides (i.e., stores and/or transmits) information in a form readable by a machine, such as a computer. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Thus, a method, apparatus, and system for low power static image display self-refresh are disclosed in various embodiments. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method, comprising:
determining that a display frame buffer has been static for a predetermined time; and
switching from a first display mode to a second display mode, wherein the second display mode is to utilize an on-die frame buffer.

2. The method of claim 1, wherein the first display mode is to utilize system memory.

3. The method of claim 1, further comprising employing a power saving mechanism with respect to at least one block in a display controller.

4. The method of claim 3, wherein employing the power saving mechanism comprises powering off at least one block in the display controller.

5. The method of claim 3, wherein employing the power saving mechanism comprises stopping a clock of at least one block in the display controller.

6. The method of claim 3, further comprising detecting a change in the display frame buffer and switching from the second display mode to the first display mode.

7. The method of claim 6, further comprising powering on the at least one block in the display controller.

8. The method of claim 1, wherein switching from a first display mode to a second display mode occurs during a vertical blank period.

9. The method of claim 1, wherein the on-die frame buffer is an embedded random access memory (RAM) for storing a compressed static image.

10. The method of claim 1, wherein determining that the display frame buffer has been static for a predetermined time comprises determining that there have been no writes to a frame buffer memory space for the predetermined time.

11. The method of claim 1, wherein determining that the display frame buffer has been static for a predetermined time comprises determining that there have been no writes to a frame buffer for a predetermined number of frames.

12. An apparatus, comprising:
a memory controller;
a first display controller coupled to the memory controller, wherein the first display controller is to control a display in a first display mode;
an embedded memory coupled to the memory controller, wherein the embedded memory is to store a compressed image during a second display mode; and
a second display controller coupled to the embedded memory, wherein the second display controller is to control the display in the second display mode.

13. The apparatus of claim 12, further comprising logic to monitor changes to a display frame buffer and to provide a signal when there is a change to the display frame buffer.

14. The apparatus of claim 13, wherein the memory controller, the first display controller, the embedded memory, the second display controller, and the logic to monitor changes to the display frame buffer are on one chip.

15. The apparatus of claim 12, wherein the embedded memory is an embedded random access memory (RAM) that is at least one megabyte (MB) in size.

16. The apparatus of claim 12, further comprising a multiplexer coupled to the first display controller and the second display controller.

17. A system comprising:
a display controller unit, wherein the display controller unit includes a memory controller, a first display controller coupled to the memory controller to control a display in a first display mode, an embedded memory coupled to the memory controller to store a compressed image, and a second display controller coupled to the embedded memory to control the display in a second display mode;
a system memory coupled to the display controller unit; and
a power management unit coupled to the display controller unit.

18. The system of claim 17, wherein the display controller unit further includes logic to monitor changes to a display frame buffer and to provide a signal to the power management unit when there is a change to the display frame buffer.

19. The system of claim 17, wherein the embedded memory is an embedded random access memory (RAM) that is at least one megabyte (MB) in size.

20. The system of claim 17, wherein the display controller unit and the power management unit are on one chip.
